(19) United States
(12) Patent Application Publication
(10) Pub. No.: US 2003/0010211 A1
(43) Pub. Date: Jan. 16, 2003

(54) Air purifier

(76) Inventor: Chi-Chin Yu, Taipei (TW)

Correspondence Address: DOUGHERTY & TROXELL, SUITE 1404, 5205 LEESBURG PIKE, FALLS CHURCH, VA, 22041, US

(21) Appl. No.: 09/901,640

(22) Filed: Jul. 11, 2001

(51) Int. Cl. B03C 3/01

(52) U.S. Cl. 96/16; 96/59

(57) ABSTRACT

An air purifier, which is mainly comprised of shell body, high-voltage electric sources, ionizing device, at least an electricity-conducting plate, and at least a set of metal filtering net set, wherein, the ionizing device and the metal filtering net set are connected to the high-voltage electric sources of same polarity. And, the electricity-conducting plates are spaced apart by the manner of appropriate distance and are arranged in parallel to the side surface of the metal filtering net set. By arranging the ionizing device at the position of air inlet, the air and micro-dusts sucked into the purifier are charged with charges. And, in the interior, by arranging a metal filtering net set comprised of at least one piece of charged metal filtering net, the charged micro-dusts in the air flowing through the metal filtering net set are expelled by the same polarity charges on the metal filtering net set and pushed toward the electricity-conducting plate located at the position adjacent to the air inlet. And, the charged micro-dusts are attracted by the different polarity charges and adsorbed onto the electricity-conducting plate to reach the function of purifying air.

### 1. FIELD OF THE INVENTION

The present invention relates to an air purifier, especially to the air purifier, wherein an ionizing device and a metal filtering net are connected to the high-voltage electricity sources with same polarity to make the sucked-in dusts, micro particles be unable to be adsorbed onto the metal filtering net set but onto the electricity-conducting plate arranged at the side of air flowing path, and additionally the positive, negative ions may be produced and followed the clean air to be exhausted outside the machine for processing second purification to further have the effect of air purification.

### 2. BACKGROUND OF THE INVENTION

Accordingly, the structure for ordinary air purifier applies the principle of electric potential difference for producing electric-corona discharge by high voltage and through the ionized metal threads located inside the air purifier, the micro dust particles are ionized and charged with charges. Then, the micro dust particles are adsorbed onto the dust-collecting plates of high voltage or of grounding located inside the air purifier for purifying the micro dust particles in the air. And, an ultraviolet-ray lamp in the interior of the purifier is applied to radiate light on a light catalyst composite coated on the filtering net inside the purifier to make the light catalyst composite generate catalysis function and the surrounding of filtering net generate free ion groups with very strong oxidation ability which can dissolve the organic gases (partly in the air) harmful to circumstance and human body to reach the object of purifying air.

However, when the air enters into the purifier, most part of the micro dust particles and impurities in the air are not absorbed onto the dust-collecting plates but followed with the air going inside the purifier. So, the ionized threads inside the purifier are easily broken because of oxidization and the filtering nets are covered with micro dust particles and impurities. And, the filtering nets are unable to be radiated by the ultraviolet-ray lamp. It is then impossible to generate catalysis function and also impossible to dissolve the organic matters and inorganic matters in the air which are harmful to the circumstance and human body. Furthermore, after the micro dusts on the dust-collecting plates are accumulated to some degree or a jumping-spark phenomenon is happened because of the collision of the dust-collecting plates caused by their uneven intervals, it would then further cause a lot of dangers and harassing matters such as electric leakage, shortage and efficiency decay or out-of-order, etc.

Another structure of air purifier, in which itself is pretreated by static electricity in advance to make its structure carry a static-electricity fiber with specific amount of charges. The polluted micro dusts of a different polarity charge are adsorbed onto its structure to fulfill the object of air purification.

However, the manner of above-mentioned structure, when the static-electricity fiber is neutralized with the polluted micro dusts with different polarity charges, the function of static electricity is no more existed. Therefore, it must renew the adsorbing structure in no time, otherwise the functions for adsorbing micro dusts and purifying air will lose. On application, it is very tedious and inconvenient.

### SUMMARY OF THE INVENTION

In responding to above requirements for improving the prior shortcomings, the inventor has finally developed and designed out an invention of air purifier, through long-term effort, research, and experiment. The purifying machine, by arranging an ionizing device at the position of its air inlet, makes the air and micro dusts that are sucked into the purifier be charged with charges. And, in the interior, by arranging a metal filtering net set comprised of at least one piece of charged metal filtering net together with an ionizing device that are connected to a high-voltage electric source with same polarity, the charged micro-dusts in the air flowing through the metal filtering net set are expelled by the same polarity charges on the metal filtering net set and pushed toward a grounded electricity-conducting plate located at the position adjacent to the air inlet. And, the charged micro-dusts are attracted by the different polarity charges and adsorbed onto the electricity-conducting plate to reach the function of purifying air. Therefore, the charged micro dusts in the air then may be adsorbed onto the electricity-conducting plate and may not be accumulated on the metal filtering net set. By doing this, it may increase the normal usage time and life for the metal filtering net.

The secondary object for the present invention is that an insulation layer is arranged on the surface of the electricity-conducting plate to make the charged micro dusts adsorbed onto the electricity-conducting plate that is grounded and arranged with an insulation layer on its surface. So, it is impossible to neutralize the charges through the electricity-conducting plate. And, the air charged with charges may be exhausted outside the machine.

Further object of the present invention is that the charges generated by the high-voltage electricity source are following the dry, clean air to be exhausted outside through the air exit and are combined again with the dust objects in the outside for cooperating the treatment of purification. On the other hand, by controlling the power of electricity source (for example, applying the high-voltage electric source of P.W.M.) or the relay on the grounding line of the electricity-conducting plate, an amount difference is generated for the charges carried out in the exhausted air. The function for removing the static charges accumulated in the outer atmosphere and objects is reached.

Another object of the present invention is that an additional ultraviolet-ray lamp tube is arranged between the two metal filtering nets of the air purifier, or between the rear electricity-conducting plate and metal filtering net set to process the sterilization function for the air flowing through thereof.

Further another object of the present invention is that a composite of light catalyst is coated on the charged metal filtering net. When the metal filtering net is conducted with high-voltage electricity or radiated by ultraviolet-ray, the composite of the light catalyst will generate reaction to filtering net and dissolve the organic matters and bacteria harmful to human body in the air flowing through the metal filtering net.

Again, one object of the present invention is that two accommodation spaces, at least two ionizing devices and metal filtering net are arranged inside the shell body of the present invention. And, two high-voltage electricity sources with different polarities are respectively connected to an ionizing device and metal filtering net set. After the sucked-in air of the present invention is purified, they may respectively exhaust out air with ions of different polarities. Because the dusts of the air outside the present invention have charged with charges of different polarities, they may be inter-attracted and combined themselves into larger micro particles and dropped down to ground because of the factor of gravity. The purpose of reducing the amount of dusts and micro particles floating in the air is reached.

Therefore, it can be effective to remove the micro dust particles, organic matters, and bacteria carried by the air. Then, the pure, clean air is exhausted outside through the air exit to reach the object of air multi-purification.

### BRIEF DESCRIPTION OF THE DRAWINGS

FIG. 1 is a cross-sectional illustration for the assembly of the present invention.

FIG. 2 is a cross-sectional illustration for the present invention.

FIG. 3 is a three-dimensional exploded view for the second embodiment of the present invention.

FIG. 4 is a cross-sectional illustration for the second embodiment of the present invention.

FIG. 5 is a distribution illustration for the positive and negative electric potentials for the second embodiment of the present invention.

FIG. 6 is a cross-sectional illustration for the third embodiment of the present invention.

FIG. 7 is a distribution illustration for the positive and negative electric potentials for the third embodiment of the present invention.

FIG. 8 is a three-dimensional exploded view for the fourth embodiment of the present invention.

### DETAILED DESCRIPTION OF THE PREFERRED EMBODIMENT

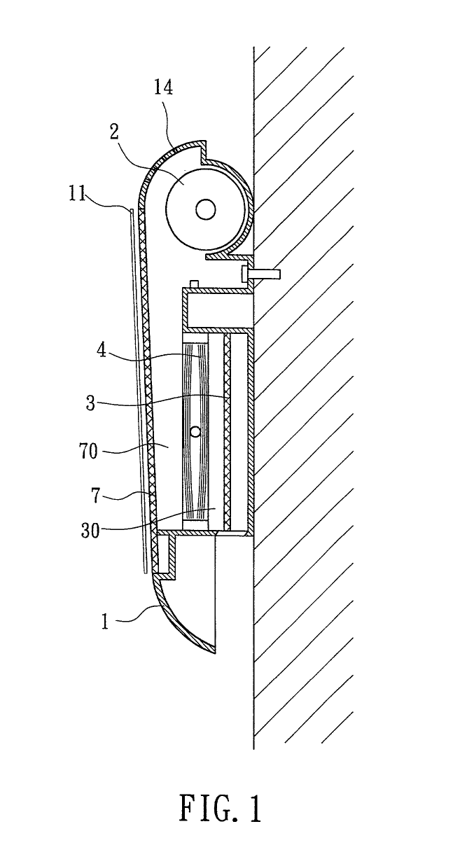

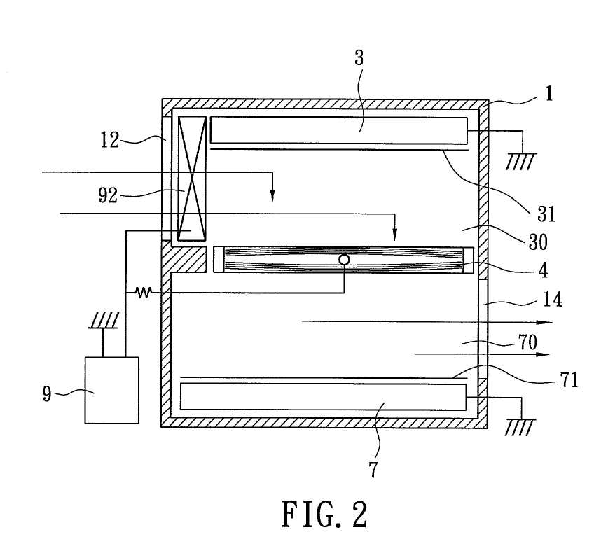

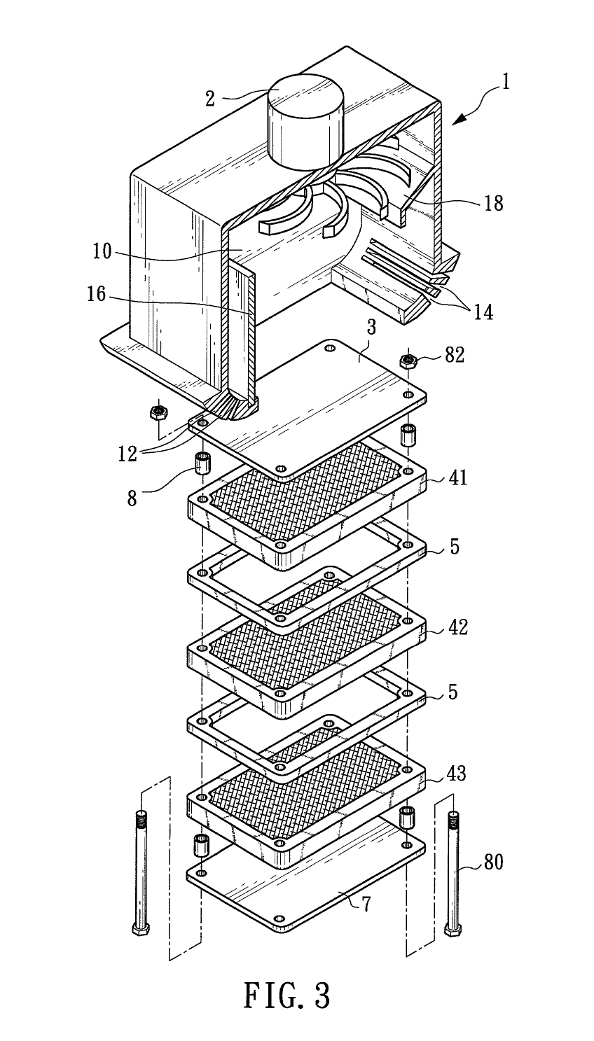

The present invention is an air purifier as shown in FIG. 1 and FIG. 3, which includes a shell body 1, and the shell body 1 is arranged with an accommodation space 10 inside thereof. At least an air inlet 12 and an air exit 14 are arranged on the shell body 1. A fan 2, arranged in the interior of the shell body 1, is applied for sucking in the outside air from the air inlet 12 and exhausting it through the exit 14. Inside the accommodation space 10, the arrangement of elements in sequence is a fore electricity-conducting plate 3, an ionizing device 92 (please refer to FIG. 2), a metal filtering net 4, and a rear electricity-conducting plate 7, etc. Wherein, the ionizing device 92 is applied for the micro dust particles flowing through thereof being charged and becoming dust particles with same polarity charge. The metal filtering net 4 is comprised of at least one piece of metal filtering net connected with same polarity high-voltage electricity source as the ionizing device. And, the grounded fore electricity-conducting plate 3 and rear electricity-conducting plate 7 are spaced apart with appropriate distance and arranged in parallel to the side of the metal filtering net plate. The fore electricity-conducting plate 3 and the rear electricity-conducting plate 7 are induced by the charged metal filtering net set to carry different polarity charges. By the aforementioned structure, the charged micro dusts in the air flowing between thereof are expelled by the same polarity charges on the metal filtering net 4 and pushed toward the fore electricity-conducting plate 3 located at the position adjacent to the air inlet 12. The charged micro dusts are attracted by the different polarity charges on the fore electricity-conducting plate 3 and adsorbed onto it. As for the arrangement of the rear electricity-conducting plate 7, its purpose is to make up the adsorption ability for the fore electricity-conducting plate 3. The effect for the fore electricity-conducting plate to absorb micro dust particles with different polarity charges is not one hundred percent of complete adsorption. So it is unavoidable that small part of micro dust particles could pass through the metal filtering net 4 and not be expelled by the same polarity charges on it. So, the micro dust particles are pushed toward the rear electricity-conducting plate 7 located at the position adjacent to the air exit 14. The effect of air purification of the present invention is made to be further perfect.

And, some light catalyst composites (such as Titanium Dioxide, Magnesium Chromite, etc.) are coated on the charged metal filtering net of the present invention. When the metal filtering net is conducted with high-voltage electricity or radiated with ultraviolet ray, the coated light catalyst will generate reaction for filtering and dissolving the organic gases harmful to human body in the air flowing through thereof. At last, when the air flows through the metal filtering net 4, wherein the unfiltered charged micro dust particles will be expelled by the same polarity charges on the metal filtering net 4 and pushed toward the rear electricity-conducting plate 7 located at the position adjacent to the air exit 14 and attracted by the different polarity charges on the electricity-conducting plate 7 and adsorbed onto it. Therefore, it can be effective for filtering out the micro dust particles, organic matters and bacteria carried in the air. Again, the purified and non-polluting air is exhausted to outer atmosphere through the air exit 14 to reach the object of air multi-purification.

Through the aforementioned structure, it may make the micro dust particles in the air be adsorbed onto the fore electricity-conducting plate 3 or the rear electricity-conducting plate 7. Therefore, the metal filtering net set 4 won't be adsorbed with too many micro dust particles. So, the present invention may greatly prolong the usage life for the metal filtering net set 4. Since to clean the metal filtering net set 4 is very inconvenient, so the design of the present invention may effectively solve the inconvenience and harassment for cleaning and changing the metal filtering net set 4 periodically.

In aforementioned structure, two insulating layers 31, 71 (as shown in FIG. 2) can be arranged on the surfaces of the electricity-conducting plates 3, 7. By arranging and covering the insulating layers 31, 37 on the surfaces of the electricity-conducting plates 3, 7, the air and micro dust particles, sucked in and passed through the ionizing device 92, will carry with charges and be adsorbed onto the grounded fore, rear electricity-conducting plates 3, 7. Then, their charges won't be neutralized through the electricity-conducting plates 3, 7. And, the amount of charges carried on the grounded electricity-conducting plates 3, 7 will be corresponded in equivalent balance with the total charges amount in the metal filtering net set 4 and the accommodation space for keeping constant adsorption ability.

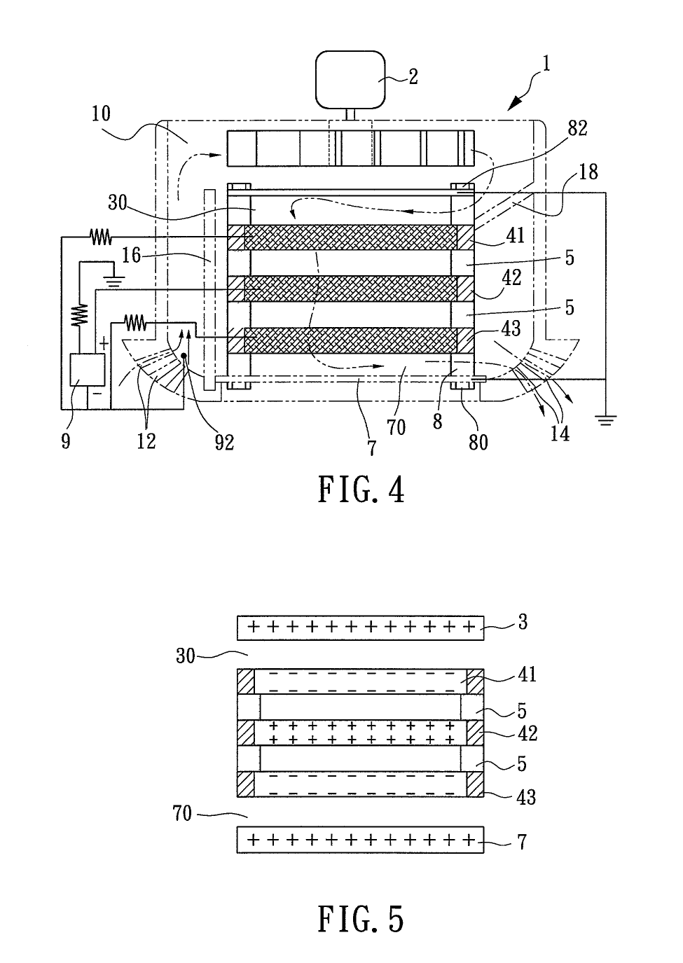

Please refer to FIG. 3, FIG. 4 and FIG. 5, which shows the second embodiment of the present invention. It is mainly arranged with a first metal filtering net set 41, a second metal filtering net set 42, and a third metal filtering net set 43. Additionally, the rear electricity-conducting plate 7 is inserted and connected on the shell body 1. The fore electricity-conducting plate 3, the first metal filtering net set 41, the second metal filtering net set 42, the third metal filtering net set 43, and the rear electricity-conducting plate 7 are spaced apart each other with an appropriate distance to form a first dust-collecting space 30 between the fore electricity-conducting plate 3 and the first metal filtering net set 4, and a second dust-collecting space 70 between the third metal filtering net set 43 and the rear electricity-conducting plate 7. And, arranging a first separating board 16 between the fore electricity-conducting plate 3 and the air inlet 12 forms an incoming air passage. By arranging a second separating board 18 to separate the fore electricity-conducting plate 3 and the air exit 14 to make the outer air sucked in through the air inlet 12 by the fan 2 and in sequence flow through the first dust-collecting space 30, the first metal filtering net set 4, the second metal filtering net set 42, the third filtering net set 43, and the second dust-collecting space 70, then finally through the air exit 14 exhausted to the outside atmosphere to form a mechanism of circulating filtration.

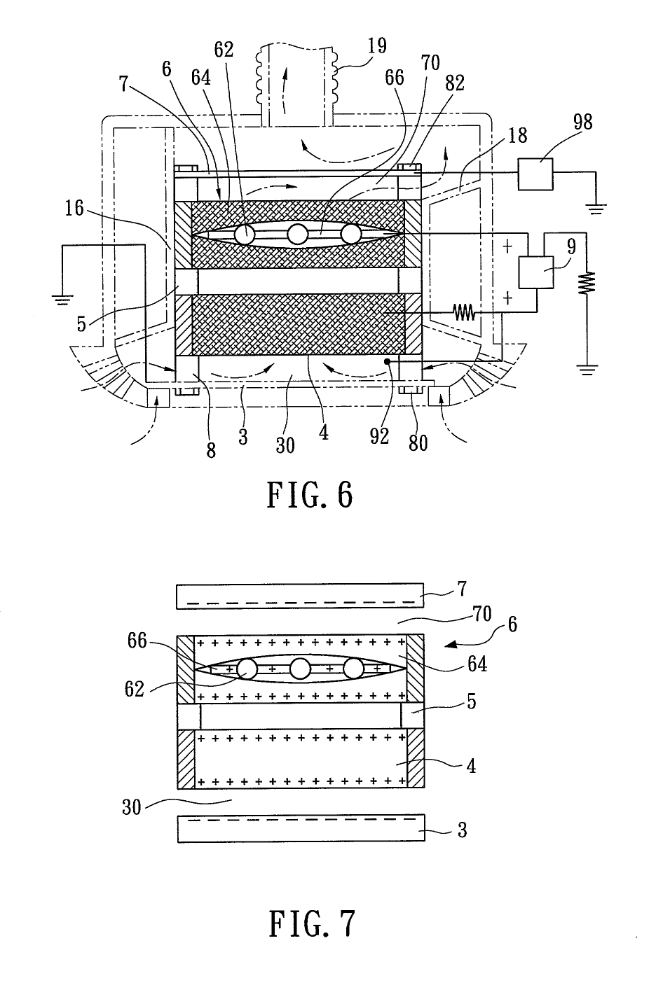

And, in the third embodiment of the present invention, please refer to FIG. 6 and FIG. 7, which show that in the air purifier of the present invention, a sterilizing device 6 can be further arranged between the fore electricity-conducting plate 3 and the metal filtering net set 4, or between the rear electricity-conducting plate 7 and the metal filtering net set 4. The sterilizing device 6 is mainly comprised of an ultraviolet-ray lamp tube 62 and a lamp tube-fixing frame 66 with electrode. It can process the sterilizing operation on the flowing through air by the aforementioned ultraviolet lamp tube 62. In the present invention, a metal filtering net set 64 can be arranged respectively in the two sides of the ultraviolet-ray lamp tube 62. A composite of light catalyst is coated respectively on the surface of each metal filtering net set 64. When the metal filtering net sets 64 are radiated by the ultraviolet-ray, the light catalyst will generate reaction for strengthening the present invention with the abilities for filtering and dissolving harmful matters and bacteria in the air. On the other hand, because of the special design of the present invention, so the surface of the metal filtering net set 4 may be effectively kept clean and without being polluted or covered by micro dust particles. Therefore, the present invention can effectively solve the shortcomings in the prior structure; namely, the metal filtering net set 4, 64 can be easily covered with micro dust particles or impurities such that the light catalyst coated on the metal filtering net set 64 can not be radiated by the ultraviolet-ray lamp 62 to effectively process catalysis. So the present invention may further fulfill the object of practical usage.

In the above-described structure, on one side of the shell body 1 adjacent to its end edge, there are arranged with several air inlets. In the shell body 1, from one side adjacent to the air inlet to the another side, there are in sequence arranged with a fore electricity-conducting plate 3, a metal filtering net set 4, a sterilizing device 6, and a rear electricity-conducting plate. Wherein, the fore electricity-conducting plate 3 is inserted and connected on the shell body 1. Another side of the shell body 1 is connected to a pipe body 19. Another end of the pipe body 19 is connected to a fan (not shown in the drawings). Through the air inlet 12, the sucked in air will be filtered and sterilized and then guided out through the pipe body 19.

In the third embodiment, arranging a first separating board 16 between the fore electricity-conducting plate 3 and the air inlet 12 forms an incoming air passage. By arranging a second separating board 18 to separate the fore electricity-conducting plate 3 and the pipe body 19 to make the outer air sucked in through the air inlet 12 by the fan 2 and in sequence flow through the first dust-collecting space 30, the metal filtering net set 4, the sterilizing device 6, and the second dust-collecting space 70, then finally through the pipe body 19 exhausted to the outside atmosphere to form a mechanism of circulating filtration.

In the above-described third embodiment as shown in FIG. 7, the fore electricity-conducting plate 3 and the rear electricity-conducting plate 7 are respectively connected to a grounding end, and the metal filtering net set 4 is then connected to an electric potential with positive phase in a high-voltage generator 9. So the positive charges are carried on the surface of the metal filtering net, and the surface of the fore electricity-conducting plate 3 generates negative charges caused by the attraction of the positive charges on the surface of the metal filtering net. In the sterilizing device 6, its metal filtering net set 64 is then connected to the electric potential with positive phase in the high-voltage generator 9. The surface of its metal filtering net is made to carry with positive charges, and the surface of the rear electricity-conducting plate 7 will carry with negative charges caused by the attraction of positive charges on the surface of the metal filtering surface. In each embodiment, on the metal filtering net set 64 of the sterilizing device 6, one side surface of the metal filtering net set 4 is carried with positive charges. So after the coated composite of light catalyst is radiated by the ultraviolet-ray lamp tube 62, on one side surface located at the position adjacent to the ultraviolet-ray lamp tube 62, pairs of electron and electric hole are formed by the light-stirring-up operation. The electrons are induced out from the electrode, and the electric holes are expelled by same polarity and quickly moved toward the another side surface farther away the ultraviolet-ray lamp tube 62. So, the surface of the metal filtering net is quickly distributed with electric holes and quickly generates ion free groups capable of strong ability of oxidation for effectively filtering and dissolving harmful organic matters and bacteria in the air.

And, in the present invention, plural separating blocks 8 with appropriate sizes may be additionally arranged between the fore electricity-conducting plate 3 and the metal filtering net set 4, and between the sterilizing device 6 and the rear electricity-conducting plate 7 to make them keep an appropriate distance between them.

In these embodiments as shown in FIG. 6, a first connecting element 80 and a second connecting element 82 are arranged among the fore electricity-conducting plate 3, the metal filtering net set 4, the sterilizing device 6, and the rear electricity-conduction plate 7 for connecting them all together. So by dismantling the first connecting element 80 and the second connecting element 82, above-mentioned elements could be dismantled easily for processing cleaning or changing. Further, on the rear electricity-conducting plate 7, of which one side surface farther from the sterilizing device 6 may be pasted on or arranged with a picturesque pattern (as shown in FIG. 1). The air purifier of the present invention appearing is made to be like a piece of artistic picture for beautifying the location or space of the arrangement.

By the means of above-mentioned air purifier, when the outside air is sucked in through the air inlet 12, the impure matters in the air are made to carry positive charges, expelled by the metal filtering net 4 and adsorbed onto the fore electricity-conducting plate 3. And, there is almost no any impure matters existing within the air flowing through the metal filtering net set 4. Then, the sterilizing device 6 is applied for effectively dissolving the organic matters and bacteria in the air harmful to circumstance and human body. The residual impurities, carrying with positive charges in the air, are expelled and adsorbed onto the rear electricity-conducting plate. Finally, the purified and carried with positive ions air is exhausted outside through the air exit 14 to reach the purpose of air multi-purification.

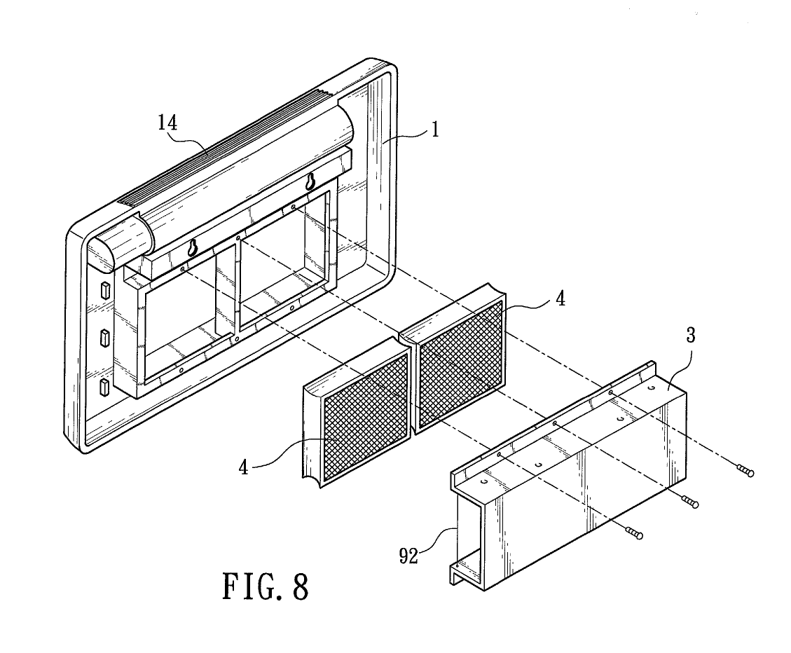

Please refer to FIG. 8, which is a fourth embodiment of the present invention. Mainly, the shell body 1 of the present invention is arranged with two accommodation spaces 10, at least two ionizing devices 92, and a metal filtering net set 4. And, two high-voltage electricity sources 9 are respectively connected with an ionizing device 92 and the metal filtering net set 4 to make the sucked in air be purified and respectively exhaust out ionized air with different polarities. On one hand, the generated negative ions will be adsorbed onto the polluting matters in the air, such as submicroscopic powders, salt, smoke, and live microorganism (bacteria, mold, virus). When the combination of pollutants and ions are collided randomly with each other in the air, they will be collected with other pollutants and condensed into blocks that will not float in the air and sink down to the floor. Another object of reducing the amount of micro dust particles floating in the air is reached. On the other hand, when the negative ions are adsorbed onto the microorganism by themselves, after a short time, the positive ions will be neutralized their charges because of random collisions. In fact, these procedures will be repeated thousand times. The balancing states of the microorganisms will be disturbed and die within couple of hours. The object of reducing the amount of microorganism then is reached.

Again, the high-voltage electricity sources in the present invention are comprised of two sets of D.C. high-voltages with different polarities, or high-voltage electricity sources with double polarities.

In the present invention, a relay 98 (as shown in FIG. 6) may be connected in series with the grounding line of the electricity-conducting plate. Controlling the relay 98 or the power of the electricity source (i.e. applying high-voltage electricity source of P.W.M.) generates an amount difference of charges carried in the exhausted air.

In summary, the present invention has the characteristics of simple structure and easy maintenance. Not only it has the effects of purifying air and removing the static electricity in circumstance, but also compared with the prior products, the present invention may indeed have the advantages of preventing jumping-spark because of the accumulation of micro dusts, electricity leakage, and shortage, etc. Additionally, it can greatly prolong the usage life of the metal filtering net and can effectively solve the shortcoming of the prior products: the light catalyst coated on the surface of the metal filtering net set can not be effectively radiated by the ultraviolet-ray to develop the expected function, because the micro dust particles in the air are easily accumulated on the surface of the metal filtering net set.

What is claimed is:

1. An air purifier, which includes:
a shell body, in which an accommodation space is arranged, and on which an air inlet and an air exit are arranged, then the outside air being sucked in through the air inlet, flowing through the accommodation space, and exhausted outside again through the air exit;
an ionizing device, which is arranged at position adjacent to the air inlet, and of which one side is connected to high-voltage electricity source, and which is applied for charging charges on the air and the micro dust particles flowing through it to make them become charged dust particles and ionized air;
at least an electricity-conducting plate, which is arranged within the accommodation space of the shell body;
at least a metal filtering net set, which is arranged within the accommodation space and is comprised of at least one piece of charged metal filtering net, and which is connected to a high-voltage electricity source with the same polarity as the that of the ionizing device;
a high-voltage electricity source, which is connected to the metal filtering net set and the ionizing device, and which provides the necessary electricity source for them.

2. The air purifier as in claim 1, wherein the electricity-conducting plate is connected with a grounding end.

3. The air purifier as in claim 2, wherein the electricity-conducting plate is arranged within the accommodation space and arranged in parallel to the side surface of the metal filtering net plate with the manner of spacing apart of appropriate distance, and its surface is induced by the charges carried on the metal filtering net set to carry with charges of different polarity.

4. The air purifier as in claim 1, wherein the surface of the electricity-conducting plate is arranged with an insulating layer.

5. The air purifier as in claim 1, wherein a side surface on the electricity-conducting plate and farther from the accommodation space may be pasted on and arranged with a picturesque pattern.

6. The air purifier as in claim 1, wherein a light catalyst materials is coated on the charged metal filtering net, when the metal filtering net is conducted with high-voltage or radiated with ultraviolet-ray, the coated light catalyst materials will generate reaction to filter and dissolve the organic matters and bacteria harmful to human body in the flowing through air.

7. The air purifier as in claim 1, wherein the present invention further includes a sterilizing device, and in which an ultraviolet-ray lamp tube is applied for processing sterilizing operation on the flowing through air.

8. The air purifier as in claim 7, wherein two sides of the ultraviolet-ray lamp tube are respectively arranged with a metal filtering net set, and on which is respectively coated with light catalyst materials, and when the metal the metal filtering net is radiated with ultraviolet-ray, the coated light catalyst will generate reaction for strengthening the abilities for filtering and dissolving harmful matters and bacteria.

9. The air purifier as in claim 7, wherein the sterilizing device is arranged between the two metal filtering net sets.

10. The air purifier as in claim 7, wherein the sterilizing device is arranged between the electricity-conducting plate and metal filtering net set.

11. The air purifier as in claim 1, wherein an insulation plate is arranged between each metal filtering net in the metal filtering net set to make each metal filtering net keep a safe distance for preventing the generation of jumping-spark between each metal filtering net.

12. The air purifier as in claim 1, wherein the high-voltage electricity source is comprised of two sets of D.C. high-voltage with different polarities.

13. The air purifier as in claim 1, wherein the high-voltage electricity source is a high-voltage source of double polarities.

14. The air purifier as in claim 1, wherein the a relay may be connected in series with the conducting line of grounding of the electricity-conducting plate located at one side of the air exit for controlling the strength of charges carried in the exhausted air.

15. The air purifier as in claim 1, wherein, two accommodation spaces and at least two ionizing devices and metal filtering net sets are arranged within the shell body of the present invention, and two sets of high-voltage electricity sources are respectively connected to one ionizing device and metal filtering net set, after the air, sucked into the present invention, has been purified, the clean air can respectively be exhausted out with ions of different polarities.
